(19) United States
(12) Patent Application Publication
(10) Pub. No.: US 2021/0021618 A1
(43) Pub. Date: Jan. 21, 2021

(54) DATA COMMUNICATION CONTROL DEVICE, NON-VOLATILE MEMORY, AND VEHICLE CONTROL SYSTEM

(71) Applicant: MITSUBISHI ELECTRIC CORPORATION, Tokyo (JP)

(72) Inventor: Masaki TANAKA, Tokyo (JP)

(73) Assignee: MITSUBISHI ELECTRIC CORPORATION, Tokyo (JP)

(21) Appl. No.: 17/032,618

(22) Filed: Sep. 25, 2020

Related U.S. Application Data
(63) Continuation of application No. PCT/JP2018/021135, filed on Jun. 1, 2018.

(51) Int. Cl. H04L 29/06

(52) U.S. Cl. CPC H04L 63/1416; H04L 63/20; H04L 63/164; H04L 63/1433

(57) ABSTRACT

To provide a data communication control device, data communication control program, and vehicle control system which control data communication in an in-vehicle network when attack data is detected in the in-vehicle network.

The data communication control device and so forth according to the present invention identify, in advance, first discard candidate data which causes trouble to occur in vehicle control when first data transmitted in the in-vehicle network is discarded, and store first discard information, which is information indicating the first discard candidate data, and first data identification information, which is information indicating the first data, in association. The data communication control device and so forth acquire attack data identification information of attack data detected in the in-vehicle network, determine the first discard candidate data indicated by first discard information associated with first data identification information matching the acquired attack data identification information as data to be discarded from the in-vehicle network, and make a discard instruction.

### CROSS REFERENCE TO RELATED APPLICATIONS

This application is a Continuation of PCT International Application No. PCT/JP2018/021135 filed on Jun. 1, 2018, which is hereby expressly incorporated by reference into the present application.

### TECHNICAL FIELD

The present invention relates to data communication control devices, data communication control programs, and vehicle control systems which control data communication in an in-vehicle network when attack data is detected in the in-vehicle network.

### BACKGROUND ART

A vehicle includes a plurality of in-vehicle devices such as the engine and the steering device and a plurality of ECUs (Electronic Control Units) for controlling the in-vehicle devices. The in-vehicle devices are each communicably connected to one of the plurality of ECUs. Also, the vehicle includes a plurality of sensors, and the plurality of sensors and the plurality of ECUs are connected via an in-vehicle network.

The ECU receives data indicating a vehicle state amount generated by a sensor or a user operation amount, generates a control signal corresponding to the state amount or the operation amount indicated by the data, and controls the in-vehicle device connected to that ECU. Also, the ECU generates data indicating a state amount of the in-vehicle device as a control target for transmission to another ECU. Based on that data, the other ECU controls another in-vehicle device.

Meanwhile, it is suggested that there is a possibility of an attack which may cause an in-vehicle device to perform abnormal operation to make the operation of the vehicle unstable. This attack is performed by rewriting a program of a sensor or ECU into an unauthorized program. Here, the sensor or ECU with its program rewritten into an unauthorized program is referred to as an attack data transmitter.

The attack data transmitter generates, as data which causes the in-vehicle device to perform abnormal operation (hereinafter referred to as attack data), abnormal data indicating a state amount that is different from a normal vehicle state amount or a normal state amount of the in-vehicle device as a control target for transmission to the ECU. Also, it generates abnormal data indicating an operation amount that is different from a normal user operation amount for transmission to the ECU. The ECU having received the attack data generates an abnormal control signal based on this attack data, and the in-vehicle device performs abnormal operation based on the abnormal control signal.

Against attacks as described above, there is an attack data discard device which detects and discards attack data transmitted in an in-vehicle network (Patent Literature 1). This attack data discard device is connected to the in-vehicle network to monitor data transmitted in the in-vehicle network. Also, the attack data discard device stores an attack data detection rule for distinguishing between normal data and attack data, and determines, based on the attack data detection rule, whether data transmitted in the in-vehicle network is attack data to detect and discard the attack data.

### CITATION LIST

### Patent Literature

Patent Literature 1: JP 2016-134914 A

### SUMMARY OF INVENTION

### Technical Problem

The attack data discard device of Patent Literature 1 detects and discards attack data in data transmitted in the in-vehicle network based on the stored attack data detection rule.

When the attack data is detected and discarded by using this attack data discard device, it is possible to prevent abnormal operation of the in-vehicle device due to the use of that attack data. However, even if the attack data is discarded, the ECU cannot receive normal data to be supposed to originally be transmitted from the attack data transmitter, and may not perform appropriate control over the in-vehicle device because of inability of receiving normal data.

Also, the ECU generates data indicating a state amount of the in-vehicle device not appropriately controlled for transmission to another ECU. By using that data, the other ECU controls another in-vehicle device. Thus, the other in-vehicle device may not be appropriately controlled, either.

As described above, there is a problem in which, even if the attack data to the in-vehicle network is discarded by using the attack data discard device of Patent Literature 1 when an attack which may cause the in-vehicle device to perform abnormal operation is given, the influence with non-transmission of normal data affects control of another ECU, thereby causing trouble to occur in vehicle control.

The present invention was made to solve the problem as described above, and has an object of providing a data communication control device, data communication control program, and vehicle control system which reduce the possibility that, when attack data is discarded in an in-vehicle network, data, which is generated by an ECU which has failed to perform appropriate control because of non-transmission of normal data from an attack data transmitter, is used for control of another ECU to cause trouble to occur in vehicle control.

### Solution to Problem

A data communication control device according to the present invention includes an attack data information acquisition part, when attack data is detected in a data group configured of a plurality of pieces of data transmitted in an in-vehicle network for use in control of a vehicle, the attack data causing abnormal operation to occur in the vehicle, to acquire attack data identification information, which is information for identifying the attack data from the data group, a discard data storage part to store first data identification information, which is information for identifying, from the data group, first data included in the data group, the first data being transmitted from a first data transmitter, and to store first discard information in association with the first data identification information, the first discard information being information indicating first discard candidate data, which is data which causes trouble to occur in control of the vehicle when the first data is discarded, a discard data determination part, when the attack data information acquisition part acquires the attack data identification information and when the attack data identification information and the first data identification information match, to read, from the discard data storage part, the first discard information associated with the first data identification information and to determine the first discard candidate data indicated by the first discard information as discard data, which is data to be discarded from the in-vehicle network, and a data discard instruction part to transmit an instruction for discarding the discard data determined by the discard data determination part from the in-vehicle network, wherein a first domain, which a plurality of data transmitter which includes the first data transmitter belongs to, is a domain causing trouble to occur in a function of the domain when the first data is discarded, and the first discard information is information indicating data transmitted from all data transmitters belonging to the first domain.

A non-volatile memory storing a data communication control program according to the present invention causes a network component connected to an in-vehicle network to function as an attack data information acquisition part, when attack data is detected in a data group configured of a plurality of pieces of data transmitted in the in-vehicle network for use in control of a vehicle, the attack data causing abnormal operation to occur in the vehicle, to acquire attack data identification information, which is information for identifying the attack data from the data group, a discard data storage part to store first data identification information, which is information for identifying, from the data group, first data included in the data group, the first data being transmitted from a first data transmitter, and to store first discard information in association with the first data identification information, the first discard information being information indicating first discard candidate data, which is data which causes trouble to occur in control of the vehicle when the first data is discarded, a discard data determination part, when the attack data information acquisition part acquires the attack data identification information and when the attack data identification information and the first data identification information match, to read, from the discard data storage part, the first discard information associated with the first data identification information and to determine the first discard candidate data indicated by the first discard information as discard data, which is data to be discarded from the in-vehicle network, and a data discard instruction part to transmit an instruction for discarding the discard data determined by the discard data determination part from the in-vehicle network, wherein a first domain, which a plurality of data transmitter which includes the first data transmitter belongs to, is a domain causing trouble to occur in a function of the domain when the first data is discarded, and the first discard information is information indicating data transmitted from all data transmitters belonging to the first domain.

A vehicle control system according to the present invention includes the data communication control device described above, and a data transmitter provided in the in-vehicle network to receive the first data and to transmit the first discard candidate data, wherein the data discard instruction part of the data communication control device transmits the instruction for discarding the discard data to the data transmitter, and when receiving the instruction from the data discard instruction part, the data transmitter stops transmission of the discard data to the in-vehicle network.

### Advantageous Effects of Invention

In the discard data storage part, the first data identification information and the first discard information are stored in association. Based on the association relation between the first data identification information and the first discard information stored in the discard data storage part, it is possible to identify the first discard candidate data as data which causes trouble to occur in vehicle control when the first data is discarded.

Thus, when attack data is detected, the first discard candidate data is identified based on the above-described association relation and a determination and instruction is made to discard that data, thereby allowing reduction of the possibility of occurrence of trouble in vehicle control.

### BRIEF DESCRIPTION OF DRAWINGS

FIG. 1 is a block diagram illustrating the configuration of a vehicle control system according to Embodiment 1 of the present invention.

FIG. 2 is a block diagram illustrating the configuration of a data communication control device according to Embodiment 1 of the present invention.

FIG. 3 is a diagram illustrating an example of a list of data identification information stored in a domain configuration database according to Embodiment 1 of the present invention.

FIG. 4 is a diagram illustrating an example of a discard policy stored in a discard policy database according to Embodiment 1 of the present invention.

FIG. 5 is a block diagram illustrating a hardware configuration for achieving the data communication control device according to Embodiment 1 of the present invention.

FIG. 6 is a flowchart illustrating a process by the data communication control device according to Embodiment 1 of the present invention.

FIG. 7 is a flowchart illustrating a process by a bridge according to Embodiment 1 of the present invention.

FIG. 8 is a flowchart illustrating a process by a data communication control device according to Embodiment 2 of the present invention.

FIG. 9 is a block diagram illustrating the configuration of a vehicle control system according to Embodiment 3 of the present invention.

### DESCRIPTION OF EMBODIMENTS

### Embodiment 1

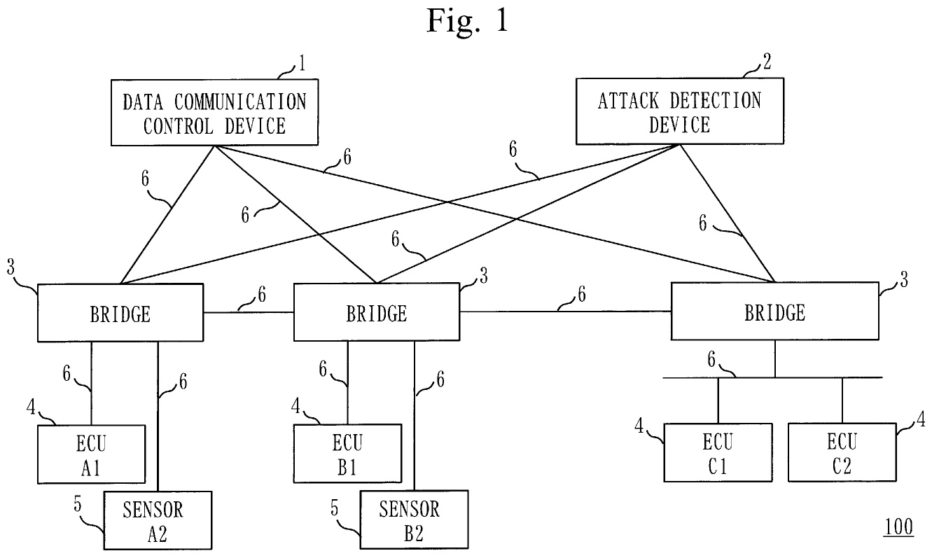

In the following, Embodiment 1 of the present invention is described with reference to FIG. 1 to FIG. 7.

FIG. 1 is a block diagram illustrating the configuration of a vehicle control system 100 according to Embodiment 1 of the present invention. First, a general outline of the vehicle control system 100 is described, and then each component included in the vehicle control system 100 is described.

The vehicle control system 100 is configured of an in-vehicle network in which a data communication control device 1, an attack detection device 2, a plurality of bridges 3, a plurality of ECUs 4, and a plurality of sensors 5 are each communicably connected via communication lines 6, performing control of a plurality of in-vehicle devices (not illustrated) mounted on a vehicle.

In the vehicle, various electronically-controlled in-vehicle devices are mounted, such as the engine, steering device, brake device, air conditioner, and navigation device. The plurality of in-vehicle devices are each communicably connected to one of the ECUs 4. The ECU 4 receives data indicating a vehicle state amount or data indicating a user operation amount transmitted in the in-vehicle network to control an in-vehicle device connected to that ECU 4 based on that data. The data indicating the vehicle state amount or the data indicating the user operation amount is generated by the ECUs 4 or the sensors 5, and is transmitted via the bridge 3 to the ECU 4 which controls the in-vehicle device.

As described above, by each ECU 4 transmitting and receiving data required for control and controlling the in-vehicle devices individually, the vehicle control system 100 controls the entire vehicle.

Note in Embodiment 1 of the present invention that the ECU 4 and the sensor 5 which generate data indicating the vehicle state amount or data indicating the user operation amount for transmission to another ECU 4 may be referred to as data transmitters. Also, the ECU 4 which receives these pieces of data to control an in-vehicle device as a control target may be referred to as a controller. The ECU 4 can serve as a data transmitter or a controller. When the ECU 4 performs a function of transmitting data, that ECU 4 is referred to as a data transmitter. When the ECU 4 performs a function of controlling an in-vehicle device based on the received data, that ECU 4 is referred to as a controller.

Here, while the data indicating the vehicle state amount mainly indicates a vehicle's traveling state or in-vehicle environment state, the data is not limited to one indicating a state of the vehicle itself but also includes data indicating a state on the periphery of the vehicle or data indicating vehicle position information.

Specific examples of that data include data about vehicle velocity, data about the number of revolutions of the engine, data about the steering angle of the wheel, data about in-vehicle temperature, and so forth. Specific examples also include data about reflected waves of ultrasonic waves transmitted toward the front of the vehicle, data about vehicle's position coordinates, and so forth.

The data indicating the user operation amount is data indicating an operation amount when the user operates the vehicle, and includes, for example, data indicating a rotation angle of the steering wheel, data indicating a depression amount of the accelerator, data about set temperature of the air conditioner, and so forth.

Also, these pieces of data are generated by the sensor 5 and the ECU 4 and transmitted to the in-vehicle network. An example is data (measurement data) indicating a state amount measured by the sensor 5. Another example is data indicating a state amount calculated by the ECU 4 based on measurement data. Still another example is data indicating a state amount of a specific in-vehicle device generated by the ECU 4 which controls that in-vehicle device.

The data indicating the vehicle state amount and the data indicating the operation amount as described above are data transmitted in the in-vehicle network for use in vehicle control, and are collectively referred to as a data group.

Also, the vehicle control system 100 includes the data communication control device 1 and the attack detection device 2 in order to address an attack which may cause an in-vehicle device to perform abnormal operation to make the operation of the vehicle unstable.

The above-described attack is performed by rewriting a program of the ECU 4 or the sensor 5 into an unauthorized program. The ECU 4 or the sensor 5 whose program has been rewritten in an unauthorized manner (attack data transmitter) generates attack data for causing the in-vehicle device to perform abnormal operation for transmission to a controller. By using the attack data, the controller generates an abnormal control signal for controlling the in-vehicle device, and the in-vehicle device performs abnormal operation based on the abnormal control signal.

Also, as another mode of the above-described attack, there is a case in which when the vehicle control system 100 can perform external communications, transmission of attack data from outside causes the controller to generate an abnormal control signal to cause the in-vehicle device to perform abnormal operation.

Here, various types of attack data generated by the attack data transmitter and attack data transmitted from outside can be thought. As one for causing the in-vehicle device to perform abnormal operation, the following attack data can be assumed.

The attack data is to cause the in-vehicle device to perform abnormal operation, and therefore is required to be received by the ECU 4 connected to the in-vehicle device as an attack target. Thus, an identifier, a data length, and so forth of the attack data similar to those of normal data are used. On the other hand, a vehicle state amount or user operation amount indicated by the attack data that is different from normal state amount or operation amount is used.

In the vehicle control system 100, the above-described attack is addressed in a manner as follows.

When detecting attack data transmitted from the attack data transmitter or from outside, the attack detection device 2 extracts, from the attack data, attack data identification information, which is information for identifying the attack data from a data group transmitted in the in-vehicle network for use in vehicle control, and transmits the extracted attack data identification information via the bridge 3 to the data communication control device 1.

The data communication control device 1 acquires the attack data identification information, determines to discard data causing trouble to occur in control of the in-vehicle device with discard of the attack data, and transmits an instruction for discarding that data to the bridge 3.

With the data communication control device 1 and the attack detection device 2 functioning as described above, the vehicle control system 100 addresses an attack which may make the operation of the vehicle unstable.

Next, each component included in the vehicle control system 100 is described.

The data communication control device 1 makes an instruction for discarding data transmitted in the in-vehicle network, and is configured of ECUs connected to the in-vehicle network.

As illustrated in FIG. 1, the data communication control device 1 is connected to the bridges 3 via the communication lines 6, and performs data communications with the attack detection device 2, the ECUs 4, and the sensors 5 via the bridges 3.

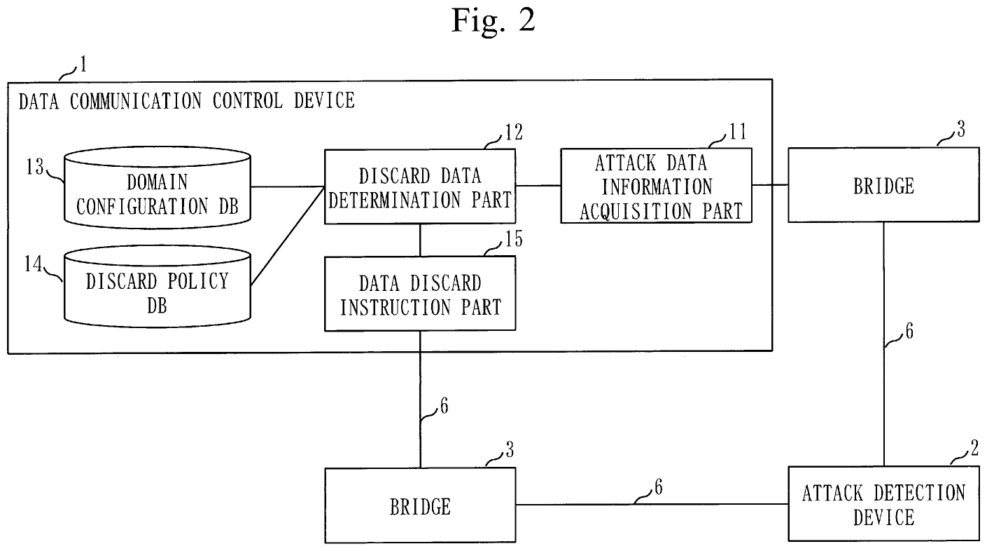

In the following, the functional configuration of the data communication control device 1 is described with reference to FIG. 2.

FIG. 2 is a block diagram illustrating the configuration of the data communication control device 1 according to Embodiment 1 of the present invention.

The data communication control device 1 includes an attack data information acquisition part 11, a discard data determination part 12, a domain configuration database 13, a discard policy database 14, and a data discard instruction part 15.

The attack data information acquisition part 11 has a function of acquiring, from the attack detection device 2, attack data identification information, which is information for identifying attack data from a data group, for use in vehicle control, transmitted in the in-vehicle network.

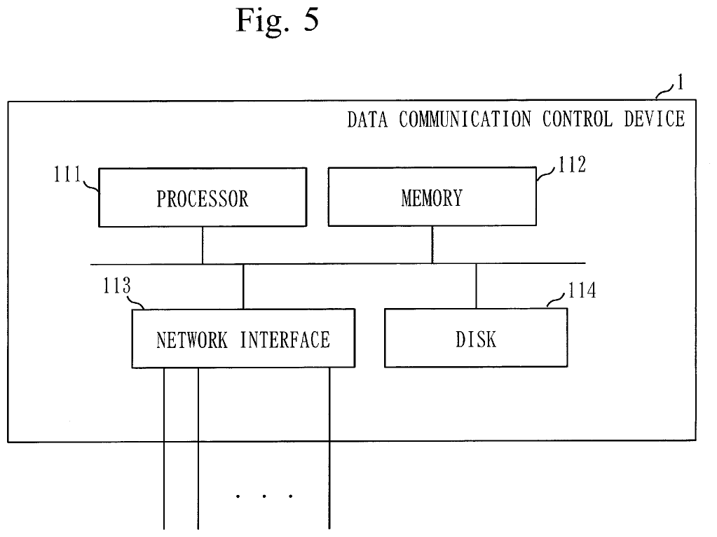

The attack data information acquisition part 11 is configured of a memory 112 or a disk (non-volatile memory) 114 storing a program for acquiring attack data identification information, a processor 111 which executes the program, and a network interface 113 connected to the bridges 3 to allow data communications (refer to FIG. 5).

The attack data information acquisition part 11 is connected to the bridges 3 via the communication lines 6, and performs communications with the attack detection device 2 via the bridges 3.

Acquisition and output of attack data identification information by the attack data information acquisition part 11 are performed in a manner as follows.

The attack detection device 2 monitors data transmitted in the in-vehicle network and, when detecting attack data, extracts attack data identification information from the attack data for transmission to the data communication control device 1. The attack data information acquisition part 11 acquires the attack data identification information transmitted from the attack detection device 2.

Upon acquiring the attack data identification information, the attack data information acquisition part 11 outputs the attack data identification information to the discard data determination part 12.

Here, the attack data identification information extracted by the attack detection device 2 from the attack data and acquired by the attack data information acquisition part 11 is described.

The attack data identification information includes information about a source of generation of the attack data and information about a use purpose of the attack data.

The information about the source of generation of the attack data has two pieces of information. One is information (corresponding to attack data transmitter information) indicating an attack data transmitter, which is a data transmitter which transmits the attack data. The other one is information (corresponding to attack data domain information) indicating a domain which the attack data transmitter belongs to. For example, the former is a transmission source address added to the header of the attack data, and the latter is an ID (Identifier) for common use in the domain.

Also, the information about the use purpose of the attack data is information (corresponding to attack data application information) indicating the use purpose of the attack data, that is, indicating by which application the attack data is used, and is, for example, a port number indicating that it is used for a specific application.

Note that the domain is a set of the ECUs 4 and the sensors 5 included for each of control systems (such as drive system, body system, and safety system) of the vehicle. Also in Embodiment 1, an ID (VLAN_ID, CAN_ID) is common to all pieces of data in a domain, and one domain corresponds to one ID.

Next, the discard data determination part 12 is described. The discard data determination part 12 has a function of determining data, which causes trouble to occur in control of the in-vehicle device with discard of the attack data, as discard data which is data to be discarded from the in-vehicle network, by using the attack data identification information acquired by the attack data information acquisition part 11 and information stored in the domain configuration database 13 and the discard policy database 14.

The discard data determination part 12 is configured of the memory 112 or the disk 114 storing a program for determining discard data and the processor 111 which executes the program (refer to FIG. 5).

Here, the domain configuration database 13 and the discard policy database 14 for use by the discard data determination part 12 in determining discard data are described.

The domain configuration database 13 and the discard policy database 14 are configured of the memory 112 or the disk 114.

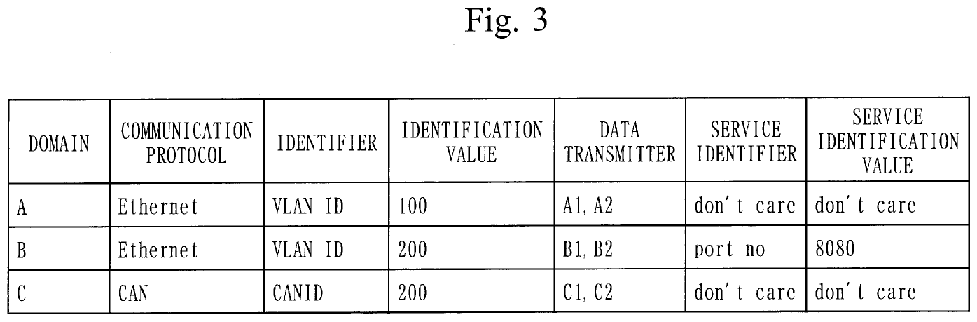

First, information stored in the domain configuration database 13 is described with reference to FIG. 3. FIG. 3 is a diagram illustrating an example of a list of data identification information stored in the domain configuration database 13 according to Embodiment 1 of the present invention.

The domain configuration database 13 stores information about a plurality of pieces of data (corresponding to first data and second data) transmitted in the in-vehicle network and under the control of the data communication control device 1. More specifically, it stores a list of data identification information (corresponding to first data identification information and second data identification information), which is information for identifying each piece of data from a data group configured of a plurality of pieces of data (refer to FIG. 3).

The above-described data identification information includes information corresponding to the attack data identification information, and includes information about a source of generation of the data and information about a use purpose of the data.

The information about the source of generation of the data has two pieces of information. One is information (corresponding to first transmitter information and second transmitter information; in FIG. 3, information in a column “data transmitter”) indicating a data transmitter which transmits the data. The other one is information (corresponding to first domain information and second domain information; in FIG. 3, information in columns “identifier” and “identification value”) indicating a domain which the data transmitter which transmits the data belongs to. For example, the former is a transmission source address added to the header of the data, and the latter is an ID (VLAN_ID or CAN_ID) for common use in the domain.

Also, the information about the use purpose of the data is information (corresponding to first application information and second application information; in FIG. 3, information in columns “service identifier” and “service identification value”) indicating the use purpose of the data, that is, indicating by which application that data is used, and is, for example, a port number indicating that it is used for a specific application.

Each piece of the data identification information stored in the domain configuration database 13 is provided with a domain name (in FIG. 3, domains A, B, and C). The domain name is a name of each domain commonly used between the domain configuration database 13 and the discard policy database 14.

By using FIG. 3, the list stored in the domain configuration database 13 is more specifically described.

In the example of FIG. 3, the data identification information corresponding to a plurality of pieces of data belonging to three domains is stored in the list. As a domain name, A, B, or C is added to each piece of data identification information. In the following, the data identification information about the data belonging to the domains A, B, and C is described along the list of FIG. 3.

The data identification information about the data belonging to the domain A is stored on an upper row of the list.

To the domain A, data with an identifier of VLAN_ID and an identification value of 100 belongs as information indicating the domain. Also, as information indicating the data transmitter, data with a data transmitter A1 and data with a data transmitter A2 belong thereto.

The data with VLAN_ID of 100 and a data transmitter A1 or A2 has one having a service identification value corresponding to a specific service identifier. However, when determining discard data among the data belonging to the domain A, the discard data determination part 12 does not use the service identifier and the service identification value. Thus, no service identifier and no service identification value are stored in this row of the domain A.

The above can be summarized as follows. On the upper row of the list, it is stored that data having data identification information with VLAN_ID of 100 and a data transmitter A1 or A2 belongs to the domain A.

The data identification information about the data belonging to the domain B is stored on an intermediate row of the list.

To the domain B, data with an identifier of VLAN_ID and an identification value of 200 belongs as information indicating the domain. Also, as information indicating the data transmitter, data with a data transmitter B1 and data with a data transmitter B2 belong thereto. Furthermore, as information indicating by which application the attack data is used, data with a service identifier of port no and a service identification value of 8080 belongs thereto.

The above can be summarized as follows. On the intermediate row of the list, it is stored that data having data identification information with VLAN_ID of 200, a data transmitter B1 or B2, and port no of 8080 belongs to the domain B.

The data identification information about the data belonging to the domain C is stored on a lower row of the list.

To the domain C, data with an identifier of CAN_ID and an identification value of 200 belongs as information indicating the domain. Also, as information indicating the data transmitter, data with a data transmitter C1 and data with a data transmitter C2 belong thereto.

As with the case of the domain A, when determining data to be discarded among the data belonging to the domain C, the discard data determination part 12 does not use the service identifier and the service identification value. Thus, no service identifier and no service identification value are stored in this row of the domain C.

The above can be summarized as follows. On the lower row of the list, it is stored that data having data identification information with CAN_ID of 200 and a data transmitter C1 or C2 belongs to the domain C.

Also, information about a communication protocol for use in each of the domains A, B, and C is stored together in the list.

As described above, in the domain configuration database 13, the data identification information is stored. The data identification information is classified for each domain which data indicated by the data identification information belongs to, and stored. By comparing the attack data identification information and the data identification information stored in the domain configuration database 13, it is possible to distinguish which domain the attack data belongs to.

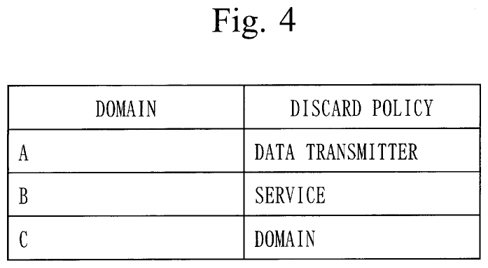

Next, information stored in the discard policy database 14 is described with reference to FIG. 4. FIG. 4 is a diagram illustrating an example of a discard policy stored in the discard policy database 14 according to Embodiment 1 of the present invention.

The discard policy database 14 has stored therein a discard policy corresponding to each domain stored in the domain configuration database 13.

The discard policy defines discard data as a discard target when attack data belonging to each domain is detected.

There are three types of discard policy: a discard policy “domain” (corresponding to first discard information), a discard policy “data transmitter” (corresponding to second discard information), and a discard policy “service” (corresponding to the second discard information). The discard policy “domain” takes all pieces of data transmitted from all data transmitters in a domain as discard data when attack data is detected in the domain. The discard policy “data transmitter” takes all pieces of data transmitted from an attack data transmitter as a source of generation of attack data as discard data when the attack data is detected in a domain. The discard policy “service” takes data for use for the same use purpose as that of attack data of data transmitted from an attack data transmitter as a source of generation of the attack data as discard data when the attack data is detected in a domain.

The discard policy “domain” has the largest range of data as a discard target, followed by the discard policy “data transmitter” and then the discard policy “service”.

The three types of discard policy are specifically described.

The discard policy “domain” is set in a case in which, when data (first data) transmitted from a data transmitter belonging to a domain is discarded, trouble occurs in the function of that domain. That is, the discard policy “domain” is set when data other than the first data included in a data group transmitted in the in-vehicle network and causing trouble to occur in vehicle control is generated.

A data transmitter which transmits the above-described first data may be referred to as a first data transmitter, and a domain which the first data transmitter belongs to may be referred to as a first domain.

Here, in which case trouble occurs in the function of the domain is described.

The domain is set for each of control systems (such as drive system, body system, and safety system) of the vehicle. The function of the domain is the function of each control system the domain is set to.

The function of the domain is performed by one or a plurality of in-vehicle devices operating. These in-vehicle devices are controlled by one or a plurality of ECUs 4 belonging to the domain.

Also, depending on the domain, with a plurality of in-vehicle devices operating in cooperation, the function of the control system is performed. In this domain, as exchanging data indicating a state amount of the in-vehicle device taken by each ECU 4 as a control target, the plurality of ECUs 4 corresponding to the plurality of in-vehicle devices perform appropriate control in the domain as a whole, thereby performing the function of the domain.

Meanwhile, when data received by one ECU is discarded as attack data, that ECU cannot receive normal data and therefore cannot perform appropriate control, but also data indicating the state amount of the in-vehicle device as a control target generated by that ECU becomes inappropriate, and other ECUs which receives that data to perform control of other in-vehicle devices cannot perform appropriate control, either. Thus, the discard of the attack data has an influence also on control of other ECUs in the domain performing control in cooperation with the ECU that cannot receive normal data due to the discard of the attack data. As a result, trouble is caused to occur in the function of that domain.

As described above, in the domain in which the plurality of in-vehicle devices operate in cooperation, discard of the attack data causes trouble to occur in the function of the domain.

As described above, when trouble occurs in the function of the domain with the discard of the data (the first data) in the domain, the discard policy “domain” of taking data (corresponding to first discard candidate data) transmitted from all data transmitters in the domain as discard data is set to that domain. The first discard candidate data taken as discard data is data generated by using the first data. Also, since the first discard candidate data is data transmitted from all data transmitter in the domain, data generated by a data transmitter that is different from the first data transmitter which transmits the first data is included.

Also, all pieces of data in the domain refer to data transmitted from all data transmitters belonging to that domain, and include data transmitted from these data transmitters to the outside of that domain.

This is because in-vehicle devices in different domains have a lower degree of cooperation than that between in-vehicle devices in a domain but have a possibility of having an influence at the time of discard of the attack data also on control of an in-vehicle device in another domain.

Next, the discard policy “data transmitter” is described. The discard policy “data transmitter” is set in a case in which, when data (corresponding to the second data) belonging to a domain is discarded, no trouble occurs in the function of that domain and a domain which the data transmitter which has transmitted the discarded data belongs to performs control regarding safety of the vehicle.

A data transmitter which transmits the above-described second data may be referred to as a second data transmitter, and a domain which the second data transmitter belongs to may be referred to as a second domain.

The case in which, when data belonging to a domain is discarded, no trouble occurs in the function of that domain refers to a case in which the in-vehicle devices do not operate in cooperation to perform the function of the domain. In other words, the case refers to a case in which, when data belonging to a domain is discarded, data (the first discard candidate data) causing trouble to occur in vehicle control does not occur.

In this case, even if attack data is discarded, this does not have an influence on the functions of that domain or the other domains. Thus, by addressing data transmitted from the attack data transmitter as a source of generation of the attack data, the influence on the operation of the vehicle by the attack data can be reduced.

In the domain set with the discard policy “data transmitter”, all pieces of data transmitted from the attack data transmitter as a source of generation of the attack data are taken as discard data.

The ECU 4 or the sensor 5 as the attack data transmitter may transmit only one piece of data or transmit a plurality of types of data to be used for different use purposes. When one type of data among the plurality of types of data is detected as attack data, there is a possibility that the attack data transmitter as a source of generation of the attack data starts transmitting attack data also for another type of data. When the other type of data is used for control regarding safety of the vehicle, this is required to be quickly addressed prior to the start of transmission of the attack data. Thus, not only data for the same use purpose as that of the attack data but also all pieces of data transmitted from the attack data transmitter are taken as discard data.

In the domain set with the discard policy “data transmitter” as described above, all pieces of data (corresponding to second discard candidate data) transmitted from the attack data transmitter are taken as discard data, but not all data (the first discard candidate data) transmitted from data transmitters in the domain which the attack data transmitter belongs to is taken as discard data. That is, in the domain set with the discard policy “data transmitter”, the first discard candidate data transmitted from the data transmitters in the domain is not discarded except the data transmitted from the attack data transmitter, and communications are maintained.

Lastly, the discard policy “service” is described. The discard policy “service” is set in a case in which, when data (the second data) belonging to a domain (the second domain) is discarded, no trouble occurs in the function of that domain and a domain which the data transmitter (the second data transmitter) which has transmitted the discarded data belongs to does not perform control regarding safety of the vehicle.

In this case, even if the attack data is discarded, this does not have an influence on the functions of that domain or the other domains. Thus, by addressing data transmitted from the attack data transmitter as a source of generation of the attack data, the influence on the operation of the vehicle by the attack data can be reduced.

In the domain set with the discard policy “service”, of the data transmitted from the attack data transmitter as a source of generation of the attack data, data for the same use purpose as that of the attack data is taken as discard data. The ECU 4 or the sensor 5 as the attack data transmitter may transmit a plurality of types of data to be used for different use purposes, and there is a possibility that attack data is started to be transmitted regarding not only the data for the use purpose for which attack data is detected but also data for another use purpose. However, if the importance for the operation of the vehicle is low, for example, when data for another use purpose does not have an influence on safety of the vehicle, the requirement to immediately address the data for the other use purpose with no attack data detected is low. Thus, of the data transmitted from the attack data transmitter as a source of generation of the attack data, data for the same use purpose as that of the attack data is taken as discard data.

In the domain set with the discard policy “service” as described above, of the data transmitted from the attack data transmitter, data (corresponding to the second discard candidate data) for the same use purpose as that of the attack data is taken as discard data, but data (the first discard candidate data) transmitted from the other data transmitters in the domain which the attack data transmitter belongs to is not taken as discard data. That is, in the domain set with the discard policy “service”, the first discard candidate data is not discarded except the data for the same use purpose as that of the attack data transmitted from the attack data transmitter, and communications are maintained.

Here, the discard policies stored in the discard policy database 14 are more specifically described by using FIG. 4.

In the example of FIG. 4, when attack data belonging to the domain A is detected, the discard policy (the second discard information) is set in which data (the second discard candidate data) transmitted from the attack data transmitter as a source of generation of the attack data is taken as discard data. In this case, even in the same domain, data except the data transmitted from the attack data transmitter as a source of generation of the attack data is not taken as discard data.

When attack data belonging to the domain B is detected, the discard policy (the second discard information) is set in which data (the second discard candidate data) transmitted from the attack data transmitter as a source of generation of the attack data and with the same service identifier and service identification value as those of the attack data is taken as discard data. In this case, even in the same domain, data except the data transmitted from the data transmitter as a source of generation of the attack data and with the same service identifier and service identification value as those of the attack data is not taken as discard data.

When attack data belonging to the domain C is detected, the discard policy (the first discard information) is set in which data (the first discard candidate data) classified as the same domain is taken as discard data. In this case, data transmitted from any data transmitter is taken as discard data as long as it is data transmitted from a data transmitter in the same domain. Also, data with any service identifier or service identification value is taken as discard data.

As described above, in the discard policy database 14, the domains and the discard policies are stored in association. When a domain which the attack data belongs to is distinguished based on the domain configuration database 13, discard data can be determined based on the discard policy database 14.

Note that the domain configuration database 13 and the discard policy database 14 correspond to a discard data storage part.

Again, with reference to FIG. 2, description of the discard data determination part 12 is made.

The discard data determination part 12 compares the attack data identification information outputted from the attack data information acquisition part 11 and the data identification information stored in the domain configuration database 13. Specifically, the discard data determination part 12 conducts a search as to whether any data identification information matching the attack data identification information is present in the data identification information stored in the domain configuration database 13.

When data identification information matching the attack data identification information is present, the discard data determination part 12 reads information about a domain name corresponding to that data identification information.

Next, the discard data determination part 12 conducts a search as to whether any information matching the domain name read from the domain configuration database 13 is present in the information about the domain name stored in the discard policy database 14. When information matching the domain name is present, the discard data determination part 12 reads the discard policy corresponding to the information about the domain name from the discard policy database 14.

When the discard policy indicates the domain, the discard data determination part 12 determines to discard all pieces of data (the first discard candidate data) in the domain which the data transmitter as a source of generation of the attack data belongs to. Specifically, since the common identifier and identification value are used in the domain, data using an identifier and an identification value similar to those included in the attack data identification information is determined as discard data.

When the discard policy indicates the data transmitter, the discard data determination part 12 determines to discard all pieces of data (the second discard candidate data) transmitted from the attack data transmitter as a source of generation of the attack data. Specifically, data using information similar to that indicating the data transmitter included in the attack data identification information is determined as discard data.

When the discard policy indicates the service, the discard data determination part 12 determines to discard data (the second discard candidate data) transmitted from the attack data transmitter as a source of generation of the attack data and for the same use purpose as the use purpose of the attack data. Specifically, data set with those similar to the information indicating the data transmitter, the service identifier, and the service identification value included in the attack data identification information is determined as discard data.

The discard data determination part 12 outputs the discard data determined as a discard target to the data discard instruction part 15.

Specifically, when all pieces of data (the first discard candidate data) in the domain are taken as discard data, the discard data determination part 12 outputs the identifier and identification value (for example, VLAN_ID and its value) included in the attack data identification information to the data discard instruction part 15 as information indicating the discard data (hereinafter referred to as discard data information).

When all pieces of data (the second discard candidate data) transmitted from the attack data transmitter are taken as discard data, the discard data determination part 12 outputs the identifier, the identification value, and the information indicating the data transmitter (for example, transmission source address) included in the attack data identification information to the data discard instruction part 15 as the discard data information.

When data (the second discard candidate data) transmitted from the attack data transmitter and for the same use purpose as the use purpose of the attack data is taken as discard data, the discard data determination part 12 outputs the identifier, the identification value, the information indicating the data transmitter, and information indicating the use purpose (for example, port number) included in the attack data identification information to the data discard instruction part 15 as the discard data information.

A specific example when the function of the discard data determination part 12 is performed is described by using the example of the domain configuration database 13 in FIG. 3 and the example of the discard policy database 14 in FIG. 4.

A case is described in which the attack data identification information acquired by the attack data information acquisition part 11 includes information with VLAN_ID of 100, a data transmitter A1, and port no of 1010.

The discard data determination part 12 searches the data identification information stored in the domain configuration database 13 for one matching the above-described attack data identification information, and reads information about the domain name associated with the matching data identification information. In this example, the data identification information about the domain A described in the upper row of the list in FIG. 3 matches the attack data identification information, and thus the information about the domain name indicating the domain A is read.

Next, the discard data determination part 12 searches the discard policy database 14 for one matching the domain A, which is the information about the domain name, and reads the discard policy corresponding to the domain A stored in the discard policy database 14. In this example, the discard policy indicating the data transmitter described on the upper row of the list in FIG. 4 is read.

Since the discard policy indicates the data transmitter, the discard data determination part 12 determines data transmitted from the data transmitter A1 as a source of generation of the attack data as discard data. Furthermore, the discard data determination part 12 outputs information indicating VLAN_ID of 100 and the data transmitter A1 to the data discard instruction part 15 as the discard data information.

A case is described in which the attack data identification information acquired by the attack data information acquisition part 11 includes information with VLAN_ID of 200, a data transmitter B2, and port no of 8080.

The discard data determination part 12 searches the data identification information stored in the domain configuration database 13 for one matching the above-described attack data identification information, and reads information about the domain name associated with the matching data identification information. In this example, the data identification information about the domain B described in the intermediate row of the list in FIG. 3 matches the attack data identification information, and thus the domain name indicating the domain B is read.

Next, the discard data determination part 12 searches the discard policy database 14 for one matching the domain B, which is the information about the domain name, and reads the discard policy corresponding to the domain B stored in the discard policy database 14. In this example, the discard policy indicating the service described on the intermediate row of the list in FIG. 4 is read.

Since the discard policy indicates the service, the discard data determination part 12 determines data transmitted from the data transmitter B2 as a source of generation of the attack data and with port no of 8080 as discard data. Furthermore, the discard data determination part 12 outputs information indicating VLAN_ID of 200, the data transmitter B2, and port no of 8080 to the data discard instruction part 15 as the discard data information.

A case is described in which the attack data identification information acquired by the attack data information acquisition part 11 includes information with CAN_ID of 200, a data transmitter C1, and port no of 8080.

The discard data determination part 12 searches the data identification information stored in the domain configuration database 13 for one matching the above-described attack data identification information, and reads information about the domain name associated with the matching data identification information. In this example, the data identification information about the domain C described in the lower row of the list in FIG. 3 matches the attack data identification information, and thus the domain name indicating the domain C is read.

Next, the discard data determination part 12 searches the discard policy database 14 for one matching the domain C, which is the information about the domain name, and reads the discard policy corresponding to the domain C stored in the discard policy database 14. In this example, the discard policy indicating the domain described on the lower row of the list in FIG. 4 is read.

Since the discard policy indicates the domain, the discard data determination part 12 determines data commonly used in that domain and with CAN_ID of 200 as data to be discarded. Furthermore, the discard data determination part 12 outputs information indicating CAN_ID of 200 to the data discard instruction part 15 as the discard data information.

In this case, not only data transmitted from the data transmitter C1 as a source of generation of the attack data but also data transmitted from the data transmitter C2 belonging to the domain C is taken as data to be discarded.

Next, the data discard instruction part 15 is described. The data discard instruction part 15 has a function of making an instruction for discarding the discard data determined by the discard data determination part 12 from the in-vehicle network.

The data discard instruction part 15 is configured of the memory 112 or the disk 114 storing a program for making a discard instruction, the processor 111 which executes the program, and the network interface 113 connected to the bridges 3 to allow data communications (refer to FIG. 5).

The data discard instruction part 15 is communicably connected to each bridge 3 in the in-vehicle network, and transmits a discard instruction to each bridge 3.

When the discard data determination part 12 determines discard data, the data discard instruction part 15 generates a command for discarding the data. With the discard data information together with the generated command taken as a discard instruction, the discard instruction is transmitted to each bridge 3.

The command for discarding the data is data using a specific ID set at the time of designing the in-vehicle network. The bridge 3 is set so as to start a discard process on that data using that specific ID when received.

To make a discard instruction, the data discard instruction part 15 transmits the data using that specific ID as a command. Also, it records the discard data information in a data field for transmission.

The discard data information is similar to one generated by the discard data determination part 12 and outputted to the data discard instruction part 15. Specifically, the discard data information is: the identifier and the identification value of the attack data when the discard policy indicates the domain; the identifier, the identification value, and the information indicating the attack data transmitter of the attack data when the discard policy indicates the data transmitter; and the identifier, the identification value, the information indicating the attack data transmitter, the service identifier, and the service identification value of the attack data when the discard policy indicates the service.

Again, FIG. 1 is referred to. So far, description of the data communication control device 1, which is a component of the vehicle control system 100, has been made. Next, the other components of the vehicle control system 100 are described.

The attack detection device 2 detects attack data on the in-vehicle network. Also, it extracts attack data identification information from attack data for transmission to the data communication control device 1.

The attack detection device 2 is configured of an ECU, and is communicably connected to the plurality of bridges 3 via the communication lines 6.

Also, the attack detection device 2 stores a determination criterion for distinguishing between normal data and attack data transmitted in the in-vehicle network as an attack data detection rule.

Since the vehicle state amount and the user operation amount indicated by the attack data are different from the normal state amount and so forth, a threshold is set in a range the normal state amount cannot take and can be used as the attack data detection rule. Also, when the state amount and so forth significantly change, it can be determined that normal data transmission has been interrupted and attack data transmission has started. Thus, a threshold is set for a change amount of the state amount and can be used as the attack data detection rule.

In addition, also when data indicating state amounts that cannot be successively taken in a normal state is successively transmitted and when data indicating an operation amount in a cycle different from a normal operation cycle by a user is transmitted, such data can be thought as attack data and thus can be used as the determination criterion.

The attack detection device 2 monitors data transmitted in the in-vehicle network and transmitted via the bridges 3.

Also, based on the attack data detection rule, the attack detection device 2 determines whether or not attack data is included in the monitored data to detect attack data.

When detecting attack data, the attack detection device 2 extracts attack data identification information from the attack data. The attack data identification information includes information about the source of generation of the attack data and information about the use purpose for which the attack data is used. The attack detection device 2 transmits the extracted attack data identification information to the data communication control device 1.

Here, as described in the example of the list in the domain configuration database 13 in FIG. 3, the in-vehicle network has a domain using VLAN_ID as an identifier based on the Ethernet protocol and a domain using CAN_ID as an identifier based on the CAN (Controller Area Network) protocol.

The attack detection device 2 recognizes a difference in frame configuration of each protocol when extracting the attack data identification information.

Specifically, an Ethernet frame has a data area called a preamble part at the start of the fame, and a CAN frame has a data area called SOF (Start Of Frame) at the start of the frame. Since these data areas are different from each other, by using this difference, the attack detection device 2 recognizes a difference in frame configuration of each protocol.

Then, the attack detection device 2 acquires attack data identification information such as an ID from the specific area of the frame.

Next, the bridge 3 is described. The bridge 3 relays data transmitted in the in-vehicle network. Also, it stops relaying of data as a discard target.

In place of the bridge 3, a switching hub or gateway can be used.

Also, the bridge 3 is communicably connected to the data communication control device 1, the attack detection device 2, the ECUs 4, and the sensors 5 via the communication lines 6.

The bridge 3 relays data transmitted between the ECUs 4 or between the ECU 4 and the sensor 5. Also, in order to make the attack detection device 2 monitor data, it transfers data to be relayed to the attack detection device 2.

Also, when the data communication control device 1 determines discard data and transmits an instruction for discarding that data to each bridge 3, each bridge 3 sets that data as a determination condition for non-relay data and stops relaying, thereby preventing that data from being used in the ECU 4.

Specifically, when receiving a command indicating a discard instruction and discard data information transmitted from the data communication control device 1, the bridge 3 reads that command and registers the discard data information in the list of discard data the bridge 3 has (hereinafter referred to as a discard data list).

The bridge 3 searches the list to check whether the data to be relayed is included in the discard data list and, when it is included in the discard data list, does not perform relay of that data.

Here, the bridge 3 in the present embodiment has a function of reading header information of each layer of data to be relayed in order to stop relay of the discard data. Specifically, the bridge 3 stores, in a memory or disk in the bridge 3, a program for reading header information of each layer of data to be relayed and performs that function by causing the processor in the bridge 3 to execute the program.

For example, in a frame based on the TCP/IP protocol, before the data field, a TCP header is added, further before which an Ethernet header is added. In the TCP header, a port number indicating a use purpose of the data is recorded. In the Ethernet header, VLAN_ID and a transmission source MAC (Media Access Control) address are recorded. The bridge 3 reads these pieces of header information, searches to check whether they match VLAN_ID and so forth of the discard data included in the discard data list, and, when they match, stops relay of that data.

Next, the ECU 4 is described. The ECU 4 performs control of an in-vehicle device based on data indicating a vehicle state amount or a user operation amount. Also, it generates data indicating a state amount of an in-vehicle device which performs control for transmission to another ECU 4.

The ECU 4 is communicably connected to the bridge 3 via the communication line 6, performing data communications with another ECU 4 or the sensor 5. Also, the ECU 4 is communicably connected to one of the plurality of in-vehicle devices mounted on the vehicle.

The ECU 4 receives data such as the vehicle state amount from another ECU 4 or the sensor 5 to generate a control signal for controlling the connected in-vehicle device for transmission to the in-vehicle device, thereby controlling the in-vehicle device.

Also, the ECU 4 acquires, from the in-vehicle device, its state amount to generate data indicating the state amount of the in-vehicle device for transmission to another ECU 4. By using that data, the other ECU 4 performs control of another in-vehicle device.

An example of the ECU 4 is one controlling an in-vehicle device such as the engine, steering device, brake device, navigation device, or air conditioner.

Next, the sensor 5 is described. The sensor 5 generates data indicating a vehicle state amount or data indicating a user operation amount for transmission to the ECU 4.

The sensor 5 is communicably connected to the bridge 3 via the communication line 6, and performs data communications with the ECU 4.

The sensor 5 generates data indicating a vehicle state amount or the like in a predetermined cycle, and sequentially transmits the data to the ECU 4. Also, it may receive a data transmission instruction from the ECU 4 to generate and transmit data.

Examples of the sensor 5 include a temperature sensor which measures temperature of the engine, a rotation angle sensor which detects an operation amount of the steering wheel by a user, and so forth.

Note that the ECUs 4 and the sensors 5 illustrated in FIG. 1 are denoted as “ECU A1”, “sensor A2”, or the like. This corresponds to information indicating data transmitters in the list in the domain configuration database 13 in FIG. 3. That is, “ECU A1” and “sensor A2” in FIG. 1 belong to the domain A, “ECU B1” and “sensor B2” belong to the domain B, and “ECU C1” and “ECU C2” belong to the domain C.

While the example is illustrated in the example of FIG. 1 in which the ECU 4 and the sensor 5 connected to one bridge 3 belong to the same domain, a domain may be set across the bridges 3.

Next, the communication lines 6 are described. The communication lines 6 are to transmit data transmitted from the data communication control device 1, the attack detection device 2, the plurality of bridges 3, the plurality of ECUs 4, and the plurality of sensors 5 (these are referred to as network components) to another network component.

There are the plurality of communication lines 6, and the communication lines 6 are each connected to the data communication control device 1, the attack detection device 2, the plurality of bridges 3, the plurality of ECUs 4, and the plurality of sensors 5.

Examples of the communication lines 6 include buses, LAN (Local Area Network) cables, or the like.

Also, with the network components being connected via the above-described communication lines 6, the in-vehicle network of the vehicle control system 100 is constructed.

Between the network components, data communications are performed based on a communication protocol such as CAN or Ethernet via the communication lines 6.

So far, description of each component of the vehicle control system 100 has been made. Also, description of each component of the data communication control device 1 included in the vehicle control system 100 has been made.

Next, a method is described, the method generating the list of data identification information stored in the domain configuration database 13 and the discard policies corresponding to the domains stored in the discard policy database 14, the domain configuration database 13 and the discard policy database 14 being described as components of the data communication control device 1.

The list of data identification information and the discard policies are generated by using a computer to virtually reproduce communications in the in-vehicle network to perform simulations and compare the simulation result in a normal state and the simulation result in an attack state with attack data discarded. In the following, description is specifically made.

On the computer, a virtual in-vehicle network corresponding to an actual in-vehicle network is designed to construct a virtual vehicle control system. Also, data acquired or inputted when the vehicle is actually operating are prepared, such as data indicating a vehicle state amount and data indicating a user operation amount when the vehicle is actually operating. By using these pieces of data, the virtual vehicle control system is virtually operated to perform simulations. By the simulations, the results are acquired, the results regarding contents of communications between virtual ECUs and virtual sensors configuring the virtual vehicle control system and contents of control signals transmitted to virtual in-vehicle devices. These results are results in a normal state of the virtual vehicle control system.

Also, with a virtual data transmitter, which is a virtual ECU or virtual sensor included in the virtual vehicle control system, being assumed to have its program rewritten in an unauthorized manner to become a virtual attack data transmitter and to start transmission of attack data, simulations are performed in a state in which data (the first data or the second data) transmitted from the virtual attack data transmitter has been discarded. By the simulations, the results are acquired, the results regarding contents of communications between virtual ECUs or between a virtual ECU and a virtual sensor configuring the virtual vehicle control system and contents of control signals transmitted to the virtual in-vehicle devices. These results are results in an attack state in which the virtual vehicle control system has been attacked and the attack data has been discarded.

By comparing the results in the normal state and the results in the attack state, in the state in which data (the first data or the second data) transmitted from the virtual attack data transmitter has been discarded, it is possible to know which influence is affected on the function of the domain which the virtual attack data transmitter belongs to, and to check trouble occurring in the function of that domain.

Similarly, with an ECU and a sensor that can be virtual attack data transmitters being each assumed to be a virtual attack data transmitter, the above-described simulations are repeated to check trouble occurring in the function of the domain.

A method of generating a list of data identification information using the results of the above-described simulations is specifically described.

First, from the communication contents as the results of the above-described simulations in the normal state, a plurality of pieces of data (the first data and the second data) transmitted in the in-vehicle network for use in vehicle control are identified. A plurality of pieces of data identification information corresponding to the identified plurality of pieces of data are classified for each domain and made into a list form. Here, since the common identifier and identification value are used in a domain, classification is possible based on the identifier and the identification value. Alternatively, since each domain is a set of data transmitters included for each of the control systems (such as drive system, body system, and safety system) of the vehicle, data transmitted from the data transmitters classified for each control system can be classified as data belonging to the same domain.

Furthermore, to data identification information about data classified as the same domain, the same domain name is added, and the data identification information is stored in the domain configuration database 13.

Note that while all pieces of data identification information of the plurality of pieces of data (the first data and the second data) for use in vehicle control may be made into a list form, only one is required to be stored when an identifier, identification value, data transmitter, service identifier, or service identification value configuring data identification information is common among the plurality of pieces of first data.

Specifically, when there are two pieces of data belonging to the domain A and having an identifier and an identification value of VLAN_ID and 100 in common and one piece of first data is transmitted from the data transmitter A1 and another piece of first data is transmitted from the data transmitter A2, as in the example of the list in FIG. 3, in the row of the domain A, one VLAN_ID is stored in the identifier column and one 100 is stored in the identification value column. Also, A1 and A2 are stored in the data transmitter column.

Next, a method of setting a discard policy for each domain is specifically described.

When it has been confirmed from comparison between the results of simulations in the normal state and the results of those in the attack state that certain data is discarded to cause trouble to occur in the function of the domain which that data belongs to, the discard policy of the domain which that data belongs to is set as the domain. In other words, the data belonging to that domain is set as data (the first discard candidate data) causing trouble to occur in vehicle control when attack data is discarded.

After it is determined whether the discard policy is set as the domain for all domains on the list, a discard policy is set for a domain for which the discard policy is not set as the domain.

When a data transmitter transmitting certain data belongs to a domain which performs a function that is important to safety of the vehicle, data transmitted from that data transmitter to be used for another use purpose is also preferably discarded in advance. Thus, when the domain for which the discard policy is not set as the domain is a domain which performs the function that is important to safety of the vehicle, the data transmitter (the second discard information) is set as a discard policy to that domain.

Also, when the domain for which the discard policy is not set as the domain is a domain which does not perform the function that is important to safety of the vehicle, the service (the second discard information) is set as a discard policy to that domain.

In a manner as described above, the list of data identification information stored in the domain configuration database 13 and the discard policies stored in the discard policy database 14 are generated.

Note that the list of data identification information stored in the domain configuration database 13 and the discard policies stored in the discard policy database 14 may be generated by using the simulation results as described above or by determining, based on an empirical rule, whether trouble occurs in vehicle control or safety of the vehicle is involved.

Next, the hardware configuration of the data communication control device 1 is described with reference to FIG. 5.

FIG. 5 is a block diagram illustrating the hardware configuration for achieving the data communication control device 1 according to Embodiment 1 of the present invention.

The data communication control device 1 is configured of an ECU, including the processor 111, the memory 112, the network interface 113, and the disk (non-volatile memory) 114.

The attack data information acquisition part 11 is implemented by the processor 111 reading and executing the program for acquiring the attack data identification information from the memory 112 or the disk 114. The discard data determination part 12 is implemented by the processor 111 reading and executing the program for determining discard data from the memory 112 or the disk 114. The data discard instruction part 15 is implemented by the processor 111 reading and executing the program for transmitting a discard instruction from the memory 112 or the disk 114.

Also, acquisition of attack data identification information by the attack data information acquisition part 11 and transmission of a discard instruction by the data discard instruction part 15 are performed by the network interface 113.

The domain configuration database 13 and the discard policy database 14 are implemented by storing the list of data identification information and discard policies in the memory 112 or the disk 114.

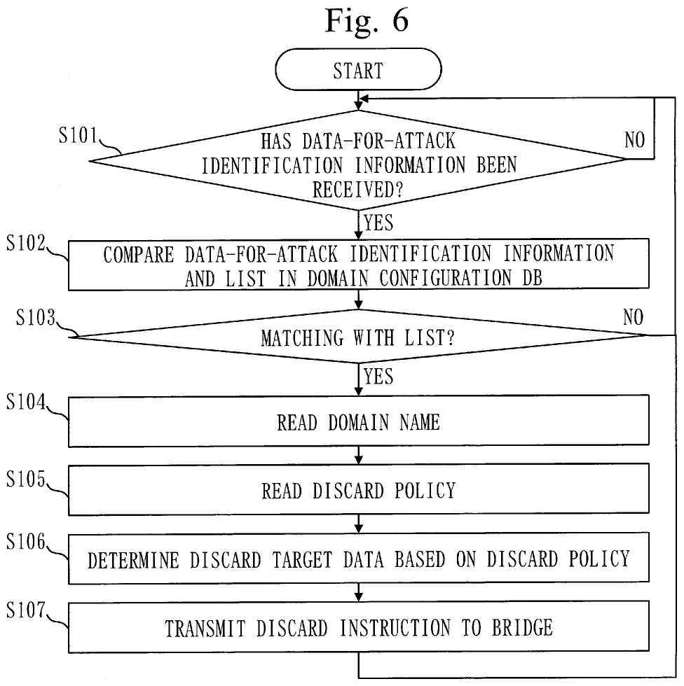

Next, the operation of the data communication control device 1 according to Embodiment 1 is described with reference to FIG. 6.

FIG. 6 is a flowchart illustrating a process by the data communication control device 1 according to Embodiment 1 of the present invention.

The process by the data communication control device 1 is started at the start of the vehicle control system 100.

Specifically, at the start of the vehicle control system 100, the processor 111 of the data communication control device 1 reads and executes a program acquiring attack data information, a program determining discard data, and a program for transmitting a discard instruction stored in the memory 112 or the disk 114.

The attack data information acquisition part 11 makes a determination as to reception of attack data identification information (step S101), and repeats determination (when NO at step S101) until receiving attack data identification information.

Specifically, since attack data identification information is transmitted from the attack detection device 2 as data with a predefined specific ID added thereto, the processor 111 of the data communication control device 1 identifies the ID of the transmitted data, and makes a determination as to reception of attack data identification information.

When the attack data information acquisition part 11 receives attack data identification information (when YES at step S101), the attack data identification information is sent from the attack data information acquisition part 11 to the discard data determination part 12. The discard data determination part 12 searches the list of data identification information stored in the domain configuration database 13 for one matching the attack data identification information (identifier, identification value, data transmitter, service identifier, and service identification value) (step S102), and determines whether the attack data identification information matches any data identification information in the list (step S103).

Specifically, the processor 111 of the data communication control device 1 determines whether the first data identification information in the list of data identification information stored in the memory 112 or the disk 114 matches the attack data identification information, and sequentially makes determination for the data identification information in the list until matching data identification information is found.

Then, when they match (when YES at step S103), the discard data determination part 12 reads the domain name corresponding to the data identification information matching the attack data identification information from the domain configuration database 13 (step S104). When the attack data identification information does not match any data identification information in the list (when NO at step S103), determination as to reception of attack data identification information is repeated until attack data identification information is received again (step S101).

Specifically, when determining that certain data identification information in the list of data identification information stored in the memory 112 or the disk 114 matches attack data identification information, the processor 111 of the data communication control device 1 reads the domain name added to that data identification information from the memory 112 or the disk 114. Also, when determining that any data identification information does not match the attack data identification information, the process returns to the process of determination as to reception of attack data identification information.

The discard data determination part 12 searches the discard policy database 14 for one matching the domain name read at step S104, and reads the discard policy corresponding to the matching domain name (step S105).

The discard data determination part 12 determines discard data based on the read discard policy (step S106).

Specifically, the processor 111 of the data communication control device 1 determines whether the information indicating the first domain name in the list of discard policies stored in the memory 112 or the disk 114 matches the information indicating the domain name previously read, sequentially making determination on the information indicating the domain name in the list until finding information indicating the matching domain name. When finding information indicating the matching domain name, the processor 111 reads the discard policy associated with that information indicating the domain name from the memory 112 or the disk 114.

When reading the discard policy “domain”, the processor 111 reads the identifier and the identification value from the attack data identification information retained in the memory 112 or the disk 114, and determines data set with the same identifier and identification value as these as discard data.

When reading the discard policy “data transmitter”, the processor 111 reads the identifier, the identification value, and the information indicating the data transmitter from the attack data identification information retained in the memory 112 or the disk 114, and determines data set with the same identifier, identification value, and information indicating the data transmitter as these as discard data.

When reading the discard policy “service”, the processor 111 reads the identifier, the identification value, the information indicating the data transmitter, the service identifier, and the service identification value from the attack data identification information retained in the memory 112 or the disk 114, and determines data set with the same identifier, identification value, information indicating the data transmitter, service identifier, and service identification value as these as discard data.

The data discard instruction part 15 acquires, from the discard data determination part 12, discard data information indicating the data determined as discard data, and generates a discard instruction for transmission to the bridge 3 (step S107).

Specifically, the processor 111 of the data communication control device 1 records, as the discard data information, the information such as the identifier indicating the determined discard data in a data field of a frame added with a specific ID, and generates a command. This command is transmitted from the network interface 113 to the bridge 3. The specific ID herein is a predefined ID for causing the bridge 3 to discard the discard data.

Thereafter, determination as to reception of attack data identification information is repeated until attack data identification information is received again (step S101).

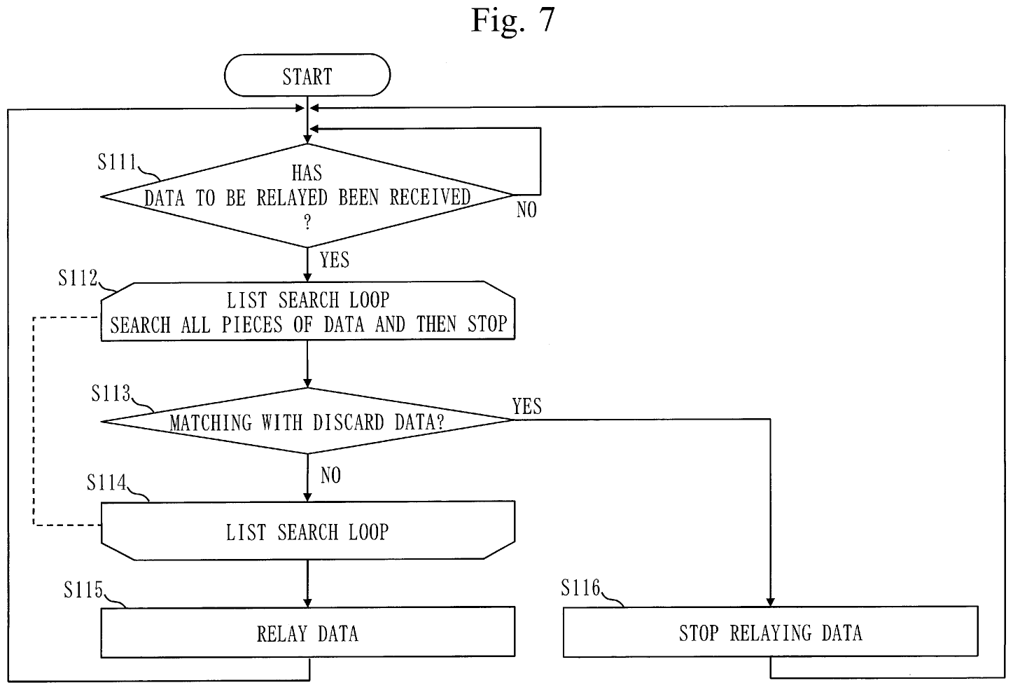

Next, the process by the bridge 3 is described by using FIG. 7. FIG. 7 is a flowchart illustrating the process by the bridge according to Embodiment 1 of the present invention.

When receiving the discard instruction command transmitted from the data communication control device 1, reading the ID, and recognizing it as a discard instruction, the bridge 3 reads the discard data information included in the discard instruction command, and adds the discard data information to the discard data list.

A process of determining, by using this discard data list, whether the bridge 3 relays data transmitted in the in-vehicle network to perform relaying or stop relaying is as follows.

The process by the bridge 3 performing relaying or stopping relaying is started at the start of the vehicle control system 100.

The bridge 3 determines whether or not data to be relayed has been received from the data transmitter connected to that bridge 3 via the communication line 6 (step S111). When data to be relayed has not been received, the determination process is repeated (when NO at step S111) until data to be relayed is received.

If data to be relayed has been received (when YES at step S111), the bridge 3 starts a process of determining whether or not the data to be relayed is data matching the discard data information included in the discard data list (step S112 to step S114). Step S112 to step S114 are a process of determining whether the data to be relayed is data matching the discard data information in the list, sequentially from one listed first in the discard data list (in FIG. 7, denoted as a list search loop). This process ends when searches of all pieces of discard data information in the list is complete. Also, the process ends when it is determined, in the course of search, that the data to be relayed is data matching the discard data information (when YES at step S113).

The bridge 3 determines whether the data to be relayed is data matching the first discard data information in the list and, when they do not match (when NO at step S113), performs the determination process on the next discard data information in a similar manner, and repeats this. When the data to be relayed is data matching the first or any discard data information in the list (when YES at step S113), this data to be relayed is discard data, and therefore data relaying is stopped (step S116).

Also, when the data to be relayed is not data matching any discard data information in the list, the bridge 3 ends the loop (step S112 to step S114), and relays the data (step S115).

Note that, for example, when the discard policy indicates the domain, the discard data information is represented by information about the identifier and the identification value. When the identifier and the identification value of the data to be relayed match the identifier and the identification value as the discard data information, that data to be relayed is determined to be data matching the discard data information.

In addition, when the discard policy indicates the data transmitter, the identifier, the identification value, and the information indicating the data transmitter represent discard data information. When the identifier, the identification value, and the information indicating the data transmitter of the data to be relayed match those as the discard data information, that data to be relayed is determined to be data matching the discard data information. When the discard policy indicates the service, the identifier, the information indicating the identification value data transmitter, the service identifier, and the service identification value represent discard data information. When the identifier, the information indicating the identification value data transmitter, the service identifier, and the service identification value of the data to be relayed match those as the discard data information, that data to be relayed is determined to be data matching the discard data information.

The data communication control device 1 according to Embodiment 1 of the present invention is configured as described above, and achieves the following effects.

The data communication control device 1 stores data identification information (the first data identification information) indicating data (the first data) transmitted in the in-vehicle network. Also, when the stored data is discarded and trouble occurs in the function of the domain which that data belongs to, the data belonging to that domain is identified in advance as data (the first discard candidate data) which causes trouble to occur in vehicle control and stored in association with the data identification information. That is, data (the first discard candidate data) which causes trouble to occur in vehicle control when the attack data is discarded is stored as the first discard information.

Also, when acquiring attack data identification information, the data communication control device 1 determines the first discard candidate data corresponding to the data identification information matching the attack data identification information as discard data.

With this, even if the attack data is discarded and trouble occurs in vehicle control, data (the first discard candidate data) as a cause of trouble can be discarded. As a result, the possibility of occurrence of trouble in vehicle control can be reduced.

Also, when data transmitted in the in-vehicle network is discarded, the data communication control device 1 sets different discard policies (the first discard information and the second discard information) for a domain causing trouble to occur in the function of the domain and a domain not causing trouble to occur in the function of the domain. By using these discard policies, all pieces of data in the domain are taken as discard data when trouble occurs in the function of the domain with the discard of the attack data, and only data transmitted from the attack data transmitter in the domain is taken as discard data when trouble does not occur in the function of the domain with the discard of the attack data.

With this, data as a cause of trouble is discarded to reduce the possibility of occurrence of trouble when trouble occurs in the function of the domain, and the data in the domain is kept as much as possible when trouble does not occur in the function of the domain, thereby allowing reduction of the possibility of occurrence of abnormal operation in the vehicle by the attack data.

Also, when trouble does not occur in the function of the domain, the data communication control device 1 further sets two different discard policies (the second discard information). When the domain which the attack data transmitter belongs to has a function regarding safety of the vehicle, all pieces of data transmitted from the attack data transmitter are taken as discard data. When it does not have a function regarding safety of the vehicle, data transmitted from the attack data transmitter and for the same use purpose as that of the attack data is taken as discard data.

With this, in accordance with the degree of influence of the attack data on safety of the vehicle, normal data can be kept, and the operation of the vehicle can be kept as much as possible.

### Embodiment 2

Next, Embodiment 2 of the present invention is described. Description is omitted for portions similar to the configuration and operation of Embodiment 1, and portions different from those in Embodiment 1 are described below.

In Embodiment 1, the discard data determination part 12 compares the attack data identification information acquired by the attack data information acquisition part 11 and the list of data identification information stored in the domain configuration database 13 and, when they match, reads the discard policy corresponding to the matching data identification information to determine discard data.

However, while the attack data identification information is configured of information about the identifier, the identification value, the data transmitter, the service identifier, and the service identification value, a case can be thought in which the attack data information acquisition part 11 cannot completely get all of these pieces of information. Examples of the case can be thought as follows: a case in which, when the attack detection device 2 extracts the attack data identification information from the attack data, an error occurs and not all pieces of information can be completely taken; a case in which not all pieces of information can be completely taken due to a problem in performance or function of the attack detection device 2; and a case in which, when the attack data identification information is transmitted from the attack detection device 2 to the attack data information acquisition part 11, a communication error occurs to damage part of the information.

In Embodiment 2, the discard data determination part 12 determines data as a discard target when a predetermined condition is satisfied even if it is not possible to acquire part of the information about the identifier, the identification value, the data transmitter, the service identifier, and the service identification value as attack data identification information as described above.

The predetermined condition is that when only part of the information is acquired as attack data identification information, there is only one piece of data identification information matching that part of the information in the domain configuration database 13. In that case, the discard policy can be determined in a uniform manner.

The same goes also for a case in which there are a plurality of pieces of data identification information matching part of the information in the domain configuration database 13 but discard policies corresponding to that plurality of pieces of data identification information match. Also in this case, the discard policy can be determined in a uniform manner.

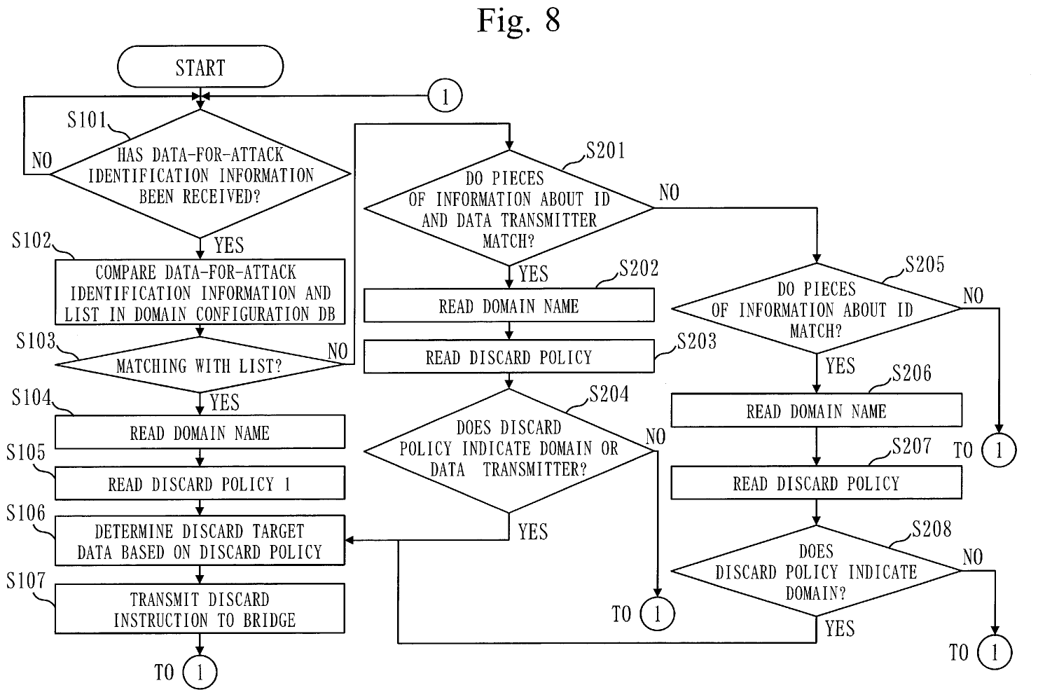

The device configuration of the data communication control device 1 according to Embodiment 2 is similar to that in Embodiment 1, but a process when it is determined that the attack data identification information and the list of data identification information stored in the domain configuration database 13 do not match (when NO at step S103 of FIG. 6) is added. The added process is described by using FIG. 8.

FIG. 8 is a flowchart illustrating a process by the data communication control device according to Embodiment 2 of the present invention.

The process from acquisition of attack data identification information to transmission of a discard instruction is similar to that in Embodiment 1 (steps S101 to S107).

When the attack data identification information acquired by the attack data information acquisition part 11 does not completely match the data identification information stored in the domain configuration database 13 (when NO at step S103), the discard data determination part 12 performs the following process. When the attack data identification information includes information about the identifier and the identification value (which are denoted as ID in FIG. 8) and the data transmitter, the discard data determination part 12 determines whether there is data identification information matching the information about the identifier, the identification value, and the data transmitter of the attack data identification information in the data identification information stored in the domain configuration database 13 (step S201).

When there is data identification information matching the information about the identifier, the identification value, and the data transmitter of the attack data identification information (when YES at step S201), a domain name corresponding to these pieces of data identification information is read (step S202). Here, since the identifier and identification value of the matching data identification information are the same, the domain is the same, and the domain name is common. Thus, the domain name corresponding to one piece of data identification information may be read.

Furthermore, the discard data determination part 12 reads, from the discard policy database 14, a discard policy corresponding to the read domain name (step S203). When the read discard policy indicates the domain (the first discard information) or the data transmitter (the second discard information) (when YES at step S204), discard data is determined based on that discard policy (step S106), and a discard instruction is transmitted to the bridge 3 (step S107).

Also, when the read discard policy does not indicate the domain or the data transmitter (when NO at step S204), the process returns to step S101 to newly receive lost attack data identification information.

Here, description is made to the reason why data as a discard target can be determined although only part of the attack data identification information is present. As the attack data identification information, information about the identifier, the identification value, and the data transmitter has been acquired, but information about the service identifier and the service identification value has not been acquired. That is, as the attack data, the domain and the data transmitter as a source of generation have been revealed from the information indicating the identifier, the identification value, and the data transmitter, but it is unknown for which use purpose the attack data is to be used.

The discard data determination part 12 determines discard data only when the discard policy indicates the domain or the data transmitter. This is because all pieces of data belonging to the domain are discarded irrespective of the use purpose for which the attack data is used when the discard policy indicates the domain, and data transmitted from the same data transmitter is discarded irrespective of the use purpose for which the attack data is used when the discard policy indicates the data transmitter. In other words, the reason is that the discard policies match irrespective of the service identifier and the service identification value and data as a discard target can be determined in a uniform manner.

By contrast, when the discard policy indicates the service, data to be discarded varies depending on the use purpose of the attack data. The reason is that, in the discard policy “service”, data for the same use purpose as the use purpose of the attack data is taken as discard data. Thus, when the discard policy indicates the service at step S204, discard data cannot be determined.

Referring back to FIG. 8, when there is no data identification information matching the information about the identifier, the identification value, and the data transmitter of the attack data identification information (when NO at step S201), the process proceeds to step S205. The same goes for a case in which the attack data identification information does not include information about the identifier, the identification value, or the data transmitter.

Next, at step S205, when there is data identification information matching the information about the identifier and the identification value of the attack data identification information (when YES at step S205), a domain name corresponding to these pieces of data identification information is read (step S206). Here, since the identifier and identification value of the matching data identification information are the same, the domain is the same, and the domain name is common. Thus, the domain name corresponding to one piece of data identification information may be read.

Furthermore, the discard data determination part 12 reads, from the discard policy database 14, a discard policy corresponding to the read domain name (step S207). When the read discard policy indicates the domain (the first discard information) (when YES at step S208), discard data is determined based on that discard policy (step S106), and a discard instruction is transmitted to the bridge 3 (step S107).

Also, when the read discard policy does not indicate the domain (when NO at step S208), the process returns to step S101 to newly receive lost attack data identification information.

When the attack data identification information does not include information about the identifier or the identification value, this is the case in which there is no data identification information matching the information about the identifier and the identification value of the attack data identification information. Thus, NO is determined at step S205, and the process returns to step S101 to newly receive lost attack data identification information.

The reason why data as a discard target can be determined although only part of the attack data identification information is present is similar to the reason previously described. As the attack data, information about the identifier and the identification value has been acquired, but information about the data transmitter, the service identifier, and the service identification value has not been acquired. That is, as the attack data, the domain as a source of generation has been revealed from the identifier and the identification value, but it is unknown from which data transmitter the attack data has been transmitted and for which use purpose the attack data is to be used.

The discard data determination part 12 determines data as a discard target only when the discard policy indicates the domain. This is because data transmitted from all data transmitters in the same domain is discarded and the attack data for any use purpose is discarded when the discard policy indicates the domain. In other words, the reason is that the discard policies match irrespective of the data transmitter, the service identifier, and the service identification value and discard data can be determined in a uniform manner.

By contrast, when the discard policy indicates the data transmitter or the service, discard data varies depending on the data transmitter as a source of generation of the attack data or the use purpose of the attack data. The reason is that, in the discard policy “data transmitter”, data transmitted from the data transmitter as a source of generation of the attack data is taken as discard data. The reason is also that, in the discard policy “service”, data for the same use purpose as the use purpose of the attack data is taken as discard data. Thus, when the discard policy indicates the data transmitter or the service at step S208, discard data cannot be determined.

The data communication control device 1 according to Embodiment 2 of the present invention is configured to perform the process as described above, and achieves the following effects.

In the data communication control device 1 according to Embodiment 2 of the present invention, even if part of the attack data identification information acquired by the attack data information acquisition part 11 is lost, data as a discard target can be determined when it is possible to select one discard policy associated with data identification information matching the partially-lost attack data identification information.

With this, even if part of the attack data identification information is lost, the influence on vehicle control due to discard of the attack data can be reduced.

### Embodiment 3

Next, Embodiment 3 of the present invention is described. Description is omitted for portions similar to the configuration and operation of Embodiment 1, and portions different from those in Embodiment 1 are described below.

Note that Embodiment 3 can be used also in combination with Embodiment 2.

In Embodiment 1, the bridge 3 receives a discard instruction transmitted from the data communication control device 1 and the bridge 3 monitors whether data as a discard target is included in data to be relayed and, when detecting data as a discard target, stops relaying that data.

On the other hand, in Embodiment 3, in place of discard of data as a discard target by the bridge 3, a communication control part 36 provided to each ECU 34 and each sensor 35 stops transmission of data as a the discard target by each ECU 34 and each sensor 35, and reduces the amount of data transmitted on the in-vehicle network.

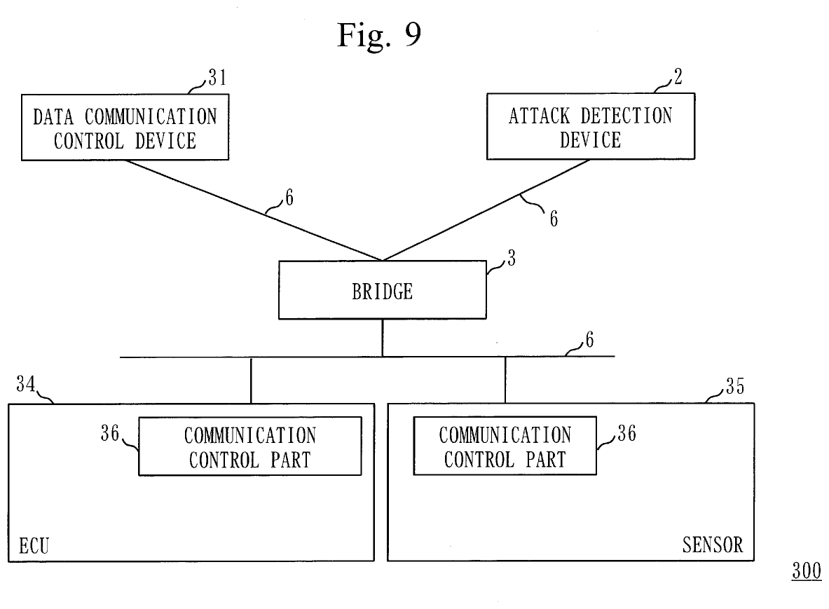

FIG. 9 is a block diagram illustrating the configuration of a vehicle control system 300 according to Embodiment 3 of the present invention.

A data communication control device 31 determines discard data in a manner similar to that of Embodiment 1 to make a discard instruction. However, a target to which the discard instruction is to be transmitted is different from that in Embodiment 1, and the communication control part 36 provided to each ECU 34 and each sensor 35 is taken as a transmission target.

The communication control part 36 is configured of, in the ECU, a memory or a disk storing a program for discarding data, a processor which executes the program, and a network interface which receives a discard instruction from the data communication control device 31.

When receiving a discard instruction transmitted from the data communication control device 31, the communication control part 36 controls generation or transmission of data transmitted from the ECU 34 or the sensor 35 to which that communication control part 36 is provided, and causes the ECU 34 or the sensor 35 to stop generation or transmission of data as a discard target.

Specifically, the communication control part 36 stores transmission data identification information, which is information indicating data to be transmitted from the ECU 34 or the sensor 35, to which that communication control part 36 is provided, to the in-vehicle network and, when receiving a command indicating a discard instruction and discard data information transmitted from the data communication control device 31, reads that command and searches for transmission data identification information matching the discard data information.

When transmission data identification information matching the discard data information is present, the communication control part 36 stops a generation process or transmission process by the ECU 34 or the sensor 35 on data indicated by the matching transmission data identification information.

The vehicle control system 300 according to Embodiment 3 of the present invention is configured as described above, and achieves the following effects.

In the vehicle control system 300 according to Embodiment 3 of the present invention, the communication control part 36 provided to each ECU 34 and each sensor 35 discards data as a discard target. With this, the discard data is discarded in the ECU 34 or the sensor 35 before being transmitted from the ECU 34 or the sensor 35 to the bridge 3. Thus, compared with a case as in Embodiment 1 in which data as a discard target is discarded at the bridge 3, the amount of data transmitted on the in-vehicle network can be reduced, and band constraint of the in-vehicle network can be held down.

Note that while the example is described in Embodiment 3 of the present invention in which the communication control part 36 provided to the ECU 34 and the sensor 35 discards discard data, in addition to discard at the ECU 34 and the sensor 35, it may be configured as in Embodiment 1 such that the bridge 3 stops relay of discard data. In the case of this configuration, the communication control part 36 may not be provided to all ECUs 34 and sensors 35.

Also, while each ECU 34 and each sensor 35 is provided with the communication control part 36 in Embodiment 3 of the present invention, in place of this, a communication control part may be provided to a HUB connected to the plurality of ECUs 34 or sensors 35 to relay communication with the bridges 3. In the case of this configuration, the communication control part 36 may not be provided to all ECUs 34 and sensors 35.

In the following, modification examples of the above-described Embodiments 1 to 3 are described.

In the above-described Embodiments 1 to 3, the discard data determined by the data communication control device 1 and the data communication control device 31 also includes attack data. Thus, an instruction for discarding attack data is not made individually. The attack detection device 2 may, however, transmit an instruction for discarding attack data when the attack detection device 2 detects the attack data. This allows the attack data to be discarded without waiting for determination as to data as a discard target by the data communication control device 1 and the data communication control device 31.

In the above-described Embodiments 1 to 3, while the data communication control device 1 and the data communication control device 31 is each configured of an ECU, it may be configured such that the function of the data communication control device 1 or 31 may be added to another network component. Here, the function of the data communication control device 1 or 31 may be generated as a program and stored in the network component for execution.

Note in FIG. 1 to FIG. 9 that the same reference character represents the same or corresponding portion.

### INDUSTRIAL APPLICABILITY

The data communication control device, data communication control program, and vehicle control system according to the present invention can be used in the field of security for attacks on in-vehicle networks.

### REFERENCE SIGNS LIST

1, 31: data communication control device; 2: attack detection device; 3: bridge; 4, 34: ECU; 5, 35: sensor; 11: attack data information acquisition part; 12: discard data determination part; 13: domain configuration database; 14: discard policy database; 15: data discard instruction part; 36: communication control part; 100, 300: vehicle control system; 111: processor; 112: memory; 113: network interface; 114: disk

1. A data communication control device comprising:
a processor:
when attack data is detected in a data group configured of a plurality of pieces of data transmitted in an in-vehicle network for use in control of a vehicle, the attack data causing abnormal operation to occur in the vehicle, to acquire attack data identification information, which is information for identifying the attack data from the data group;
to store first data identification information, which is information for identifying, from the data group, first data included in the data group, the first data being transmitted from a first data transmitter, and to store first discard information in association with the first data identification information, the first discard information being information indicating first discard candidate data, which is data which causes trouble to occur in control of the vehicle when the first data is discarded;
when the processor acquires the attack data identification information and when the attack data identification information and the first data identification information match, to read, from the processor, the first discard information associated with the first data identification information and to determine the first discard candidate data indicated by the first discard information as discard data, which is data to be discarded from the in-vehicle network; and
to transmit an instruction for discarding the discard data determined from the in-vehicle network, wherein
a first domain, which a plurality of data transmitter which includes the first data transmitter belongs to, is a domain causing trouble to occur in a function of the domain when the first data is discarded, and
the first discard information is information indicating data transmitted from all data transmitters belonging to the first domain.

2. The data communication control device according to claim 1, wherein
the processor stores second data identification information, which is information for identifying second data included in the data group from the data group, the second data being transmitted from a second data transmitter, and stores second discard information, which is information indicating second discard candidate data, the second discard candidate data being data causing trouble to occur in control of the vehicle when the second data is discarded, in association with the second data identification information,
when the processor acquires the attack data identification information and when the attack data identification information matches the second data identification information, the processor reads the second discard information, which is associated with the second data identification information, from the processor and determines data indicated by the second discard information as the discard data, wherein
a second domain, which a plurality of data transmitter which includes the second data transmitter belongs to, is a domain not causing trouble to occur in a function of the domain when the second data is discarded, and
the second discard information is information indicating data transmitted from the second data transmitter of data transmitters belonging to the second domain.

3. The data communication control device according to claim 2, wherein
the second discard information is information indicating all pieces of data transmitted from the second data transmitter when the second domain has a function regarding safety of the vehicle and is information indicating data to be used for a use purpose common to a use purpose of the second data in the data transmitted from the second data transmitter when the second domain does not have the function regarding safety of the vehicle.

4. The data communication control device according to claim 2, wherein
the first data identification information includes first transmitter information, which is information indicating the first data transmitter; first domain information, which is information indicating the first domain; and first application information, which is information indicating a use purpose of the first data,
the second data identification information includes second transmitter information, which is information indicating the second data transmitter; second domain information, which is information indicating the second domain; and second application information, which is information indicating a use purpose of the second data,
the attack data identification information includes attack data transmitter information, which is information indicating an attack data transmitter as a data transmitter which transmits the attack data; attack data domain information, which is information indicating a domain which the attack data transmitter belongs to; and attack data application information, which is information indicating a use purpose of the attack data, and
when the first data identification information including the first domain information matching the attack data domain information acquired as part of the attack data identification information is stored in the processor, the processor reads the first discard information and determines the first discard candidate data indicated by the first discard information as the discard data.

5. The data communication control device according to claim 3, wherein
the first data identification information includes first transmitter information, which is information indicating the first data transmitter; first domain information, which is information indicating the first domain; and first application information, which is information indicating a use purpose of the first data,
the second data identification information includes second transmitter information, which is information indicating the second data transmitter; second domain information, which is information indicating the second domain; and second application information, which is information indicating a use purpose of the second data,
the attack data identification information includes attack data transmitter information, which is information indicating an attack data transmitter as a data transmitter which transmits the attack data; attack data domain information, which is information indicating a domain which the attack data transmitter belongs to; and attack data application information, which is information indicating a use purpose of the attack data, and
when the first data identification information including the first domain information matching the attack data domain information acquired as part of the attack data identification information is stored in the processor, the processor reads the first discard information and determines the first discard candidate data indicated by the first discard information as the discard data.

6. The data communication control device according to claim 1, wherein
the first discard candidate data is data generated by using the first data.

7. The data communication control device according to claim 1, wherein
the first discard candidate data is data generated by a data transmitter that is different from the data transmitter which transmits the first data.

8. A data communication control device comprising:
a processor to:
store a discard policy in advance for each of domains, the each of domains being a set of data transmitters included for each of control systems of a vehicle;
determine, based on the discard policy, data causing trouble to occur in a control of an in-vehicle device by discarding the attack data, as discard data, which is a discard target, when an attack data, which causes an abnormal operation to occur in the vehicle, is detected in each domain; and
transmit an instruction for discarding the discard data determined from the in-vehicle network, wherein
the discard policy defines the discard data as a discard target, when the attack data belonging to each domain is detected, and
the processor stores, a different discard policy for a domain causing trouble to occur in a function of the domain and a domain not causing trouble to occur in a function of the domain when the attack data is discarded.

9. The data communication control device according to claim 8, wherein
the processor stores, as the discard policy, each of “domain”, “data transmitter”, and “service”,
“domain”, which is one discard policy, is set in a case where, when the attack data is discarded, causing trouble to occur in a function of a domain which a data transmitter which has transmitted the discarded data belongs to, and defines, as the discard data, data transmitted from all data transmitters included in a domain which a data transmitter which has transmitted the attack data belongs to,
“data transmitter”, which is one discard policy, is set in a case where, when the attack data is discarded, not causing trouble to occur in a function of a domain which a data transmitter which has transmitted the attack data belongs to, and in a case where a domain which a data transmitter which has transmitted the attack data belongs to performs control regarding safety of the vehicle, and defines, as the discard data, all data transmitted from the data transmitter which has transmitted the attack data,
“service”, which is one discard policy, is set in a case where, when the attack data is discarded, not causing trouble to occur in a function of a domain which a data transmitter which has transmitted the attack data belongs to, and in a case where a domain which a data transmitter which has transmitted the attack data belongs to does not perform control regarding safety of the vehicle, and defines, as the discard data, of data from a transmitter which has transmitted the attack data, data for the same use purpose as the use purpose of the attack data.

10. The data communication control device according to claim 9, wherein
when attack data is detected in a data group configured of a plurality of pieces of data transmitted in an in-vehicle network for use in control of a vehicle, the processor acquires attack data identification information, which is information for identifying the attack data from the data group,
the processor stores a list of data identification information for identifying each data from the data group,
the attack data identification information includes attack data transmitter information, which is information indicating attack data transmitter being a data transmitter which transmits the attack data, attack data domain information, which is information indicating a domain which the attack data transmitter belongs to, and attack data application information, which is information indicating a use purpose of the attack data, and
when the processor, of the attack data identification information, is able to acquire only the attack data domain information and is not able to acquire the attack data transmitter information and the attack data application information,
the processor reads, from the list, the data identification information including domain information matching the attack data domain information, and when the discard policy set for a domain indicated by the read data identification information is “domain”, determines the discard data based on the discard policy “domain”.

11. A non-volatile memory storing a data communication control program that causes a network component connected to an in-vehicle network to function as:
an attack data information acquisition part, when attack data is detected in a data group configured of a plurality of pieces of data transmitted in the in-vehicle network for use in control of a vehicle, the attack data causing abnormal operation to occur in the vehicle, to acquire attack data identification information, which is information for identifying the attack data from the data group;
a discard data storage part to store first data identification information, which is information for identifying, from the data group, first data included in the data group, the first data being transmitted from a first data transmitter, and to store first discard information in association with the first data identification information, the first discard information being information indicating first discard candidate data, which is data which causes trouble to occur in control of the vehicle when the first data is discarded;
a discard data determination part, when the attack data information acquisition part acquires the attack data identification information and when the attack data identification information and the first data identification information match, to read, from the discard data storage part, the first discard information associated with the first data identification information and to determine the first discard candidate data indicated by the first discard information as discard data, which is data to be discarded from the in-vehicle network; and
a data discard instruction part to transmit an instruction for discarding the discard data determined by the discard data determination part from the in-vehicle network, wherein
a first domain, which a plurality of data transmitter which includes the first data transmitter belongs to, is a domain causing trouble to occur in a function of the domain when the first data is discarded, and
the first discard information is information indicating data transmitted from all data transmitters belonging to the first domain.

12. A vehicle control system comprising:
the data communication control device according to claim 1; and
a data transmitter provided in the in-vehicle network to receive the first data and to transmit the first discard candidate data, wherein
the processor of the data communication control device transmits the instruction for discarding the discard data to the data transmitter, and when receiving the instruction from the processor, the data transmitter stops transmission of the discard data to the in-vehicle network.
